(19) United States
(12) Patent Application Publication
(10) Pub. No.: US 2012/0158466 A1
(43) Pub. Date: Jun. 21, 2012

(54) PARKING METER SYSTEM WITH AUTOMATED TICKET GENERATION FOR A VIOLATION

(75) Inventor: Thomas John, New Hyde Park, NY (US)

(73) Assignee: American Gardens Management Co., New Hyde Park, NY (US)

(21) Appl. No.: 13/282,752

(22) Filed: Oct. 27, 2011

Related U.S. Application Data
(60) Provisional application No. 61/411,161, filed on Nov. 8, 2010.
(60) Provisional application No. 61/407,333, filed on Oct. 27, 2010.

(51) Int. Cl. G07B 15/00

(52) U.S. Cl. 705/13

(57) ABSTRACT

The present invention relates to parking meters, and in particular, to an automated parking meter that recognizes a parker by reading an identification card, such as a car registration, insurance card, license, etc., and is configured to visually display the current status of the vehicle and is configured so that in the event that the meter expires or payment is not made, a ticket can be generated and delivered to the parker.

### CROSS REFERENCE TO RELATED APPLICATIONS

This application claims the benefit of U.S. Patent Application Ser. No. 61/411,161, filed Nov. 8, 2010, and U.S. Patent Application Ser. No. 61/407,333, filed Oct. 27, 2010, which are hereby incorporated by reference in their entireties.

### TECHNICAL FIELD

The present invention relates to parking meters, and in particular, to an automated parking meter that recognizes a parker by reading an identification card, such as a car registration, insurance card, license, etc., and is configured to visually display the current status of the vehicle and is configured so that in the event that the meter expires or payment is not made, a ticket can be generated and delivered to the parker.

### BACKGROUND

Parking meters allocate parking spaces for a limited amount of time. That is, by depositing money into a parking meter, a driver purchases a limited amount of time for which to park his or her vehicle in a particular parking space. The time purchased through the meter is the maximum amount of time the driver is allowed to park his or her vehicle in the parking space. Once the driver has exceeded his or her allotted time, the driver has committed a legal violation and is potentially liable for fines to the municipality (or a private entity) that owns the parking meter. A citation, which generally provides notice of the violation and a fine, may be attached directly to the vehicle, for example, under a wiper blade. Alternatively, the citation may be mailed directly to the vehicle owner, who can be identified, for example, by running the license plate of the vehicle through a license plate database. Because a municipality (or a private entity) can collect money from the parking meter itself and from fines in enforcing unpaid/expired parking meters, parking meters provide a significant source of revenue to municipalities.

Many municipalities are replacing traditional, single-bay/single-space parking meters with multi-bay/multi-space parking meters. Whereas the traditional single-bay parking meter accepts only coins, the multi-bay parking meter may accept any of a variety of payment options, including paper money, credit cards, debit cards, and smart cards. Because one multi-bay parking meter potentially replaces numerous single-bay parking meters, the multi-bay parking meter saves space and is easier to maintain. Further, money collected from multiple parking spaces can be retrieved from one multi-bay parking meter, as opposed to numerous single-bay parking meters.

Although the multi-bay parking meter provides many advantages over the single-bay parking meter, both the single-bay and the multi-bay parking meters currently require human enforcement. That is, enforcement of parking meters is typically carried out by parking enforcement officers using handheld citation devices. One of the problems with human enforcement is cost. Many municipalities simply cannot afford the cost of hiring parking enforcement officers. Another problem with human enforcement is lost revenue. Revenue is lost when a citation is not timely issued for an expired/unpaid parking meter. Each parking enforcement officer is typically assigned to enforce numerous parking meters and/or parking spaces. Consequently, the parking enforcement officer cannot logistically monitor every parking meter and/or parking space simultaneously. This is particularly troublesome in the case of single-bay parking meters where a parking enforcement officer would need to check each individual parking meter. However, even in the case of the multi-bay parking meter, a parking enforcement officer would still need to process and print a citation for each individual car. The process can take several minutes, and a parking enforcement officer typically can issue only one citation at any given time. Not only is such a task onerous and time-consuming, in many cases, the parking enforcement officer may not immediately recognize that time for another parking space has expired. Especially in a situation where several parking spaces expire near the same time, the drivers of the other vehicles may come back to their cars after the parking meter has expired but before a citation can be issued. As a result, the municipality loses the revenue from potential fine payments because the citation was not immediately issued when the parking meter expired or is determined to be unpaid.

There is therefore a need to have a more efficient meter that recognizes the identification of the vehicle and/or driver of the vehicle that is parked in a particular spot and can generate a violation ticket without human enforcement.

### SUMMARY

The present invention relates to parking meters, and in particular, to an automated parking meter that recognizes a parker by reading an identification card, such as a car registration, insurance card, license, etc., and is configured to visually display the current status of the vehicle and is configured so that in the event that the meter expires or payment is not made, a ticket can be generated and delivered to the parker.

These and other aspects, features and advantages shall be apparent from the accompanying Drawings and description of certain embodiments of the invention.

### BRIEF DESCRIPTION OF THE DRAWINGS

FIG. 1 is a simplified block diagram of an automated parking enforcement system in accordance with one embodiment of the present invention;

FIG. 2 is a front view of a parking meter;

FIG. 3 is a view of the parking meter and vehicle sensor mechanism;

FIG. 4 is a front view of a master controller; and

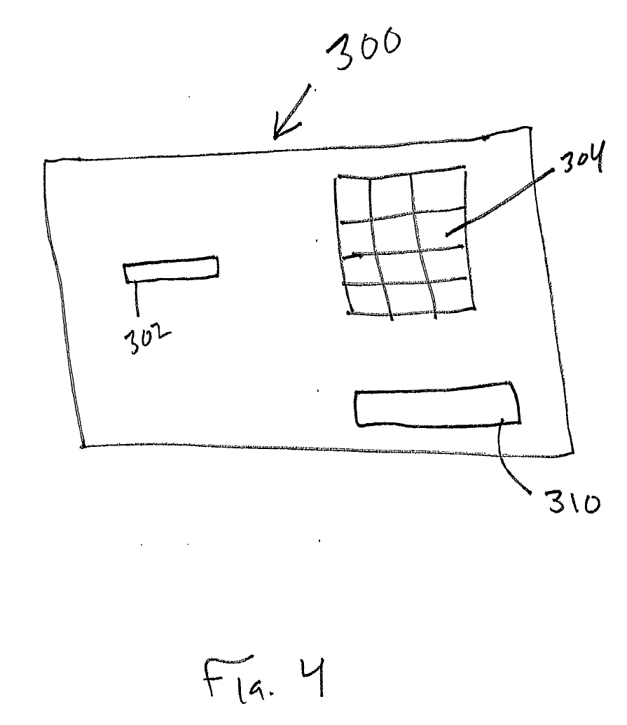

FIG. 5 is a parking meter system and camera system.

### DETAILED DESCRIPTION OF CERTAIN EMBODIMENTS OF THE INVENTION

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachers herein, one of ordinary skill in the related art will be able to contemplate these and similar implementations of the present invention.

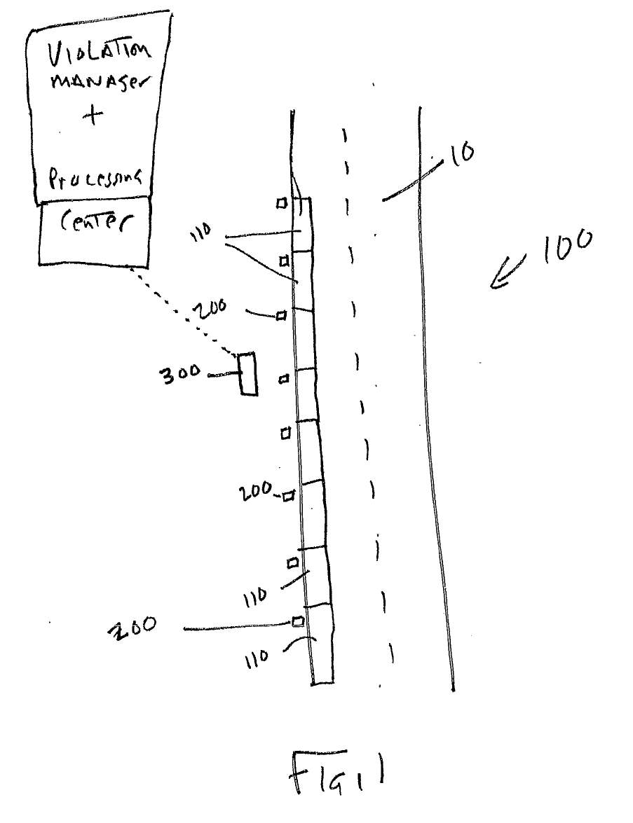

FIG. 1 is a simplified block diagram of an automated parking enforcement system 100 in accordance with one embodiment of the present invention. The system 100 can not only be implemented for on-street parking spots but also for a parking lot, such as a municipal parking lot. For ease of illustration, the system 100 of FIG. 1 is an on-street parking system in which two parking spots 110 are shown as is the case when the spots 110 are located in series along the side of a street 10.

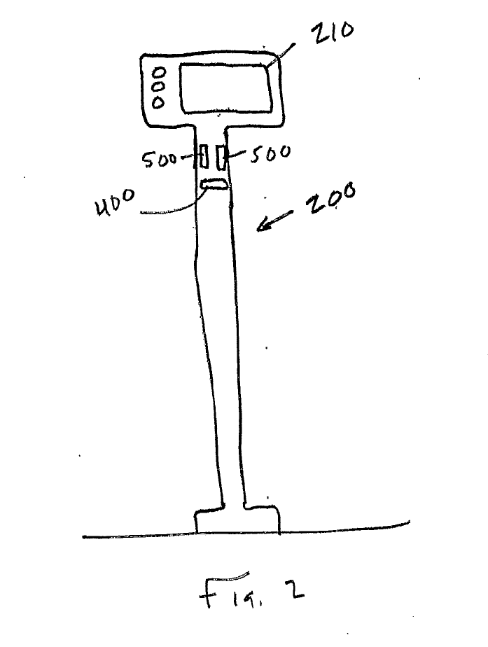

The system 100 can include a plurality of meter displays 200 that are located along the side of the street 10. As shown in FIG. 2, the meter display 200 can be similar to existing pole parking meters that are fed coins or it can be simply an upstanding structure that has a display 210 that is part thereof. It will also be appreciated that the meter display 200 can be incorporated into an existing structure such as a sign or the like so long as the location of the sign relative to the street 10 is satisfactory. In the illustrated embodiment, the meter displays 200 are in the form of upstanding poles that are spaced along the street 10 and include the display 210. For example, one meter display 200 can be unique to one parking spot 110 or one meter display 200 can be used for two adjacent sports 110.

The display 210 can be a conventional LCD screen or the like that permits information to be displayed. In the illustrated embodiment, the display 210 is configured to have a display indicator, in the form of a light that represents certain operating conditions (modes) of the meter. For example, different colors can be displayed on the display 210 to transmit information to the driver of the vehicle and optionally to a third party, such as a police officer or the like. Exemplary information that is displayed is discussed herein and can include but is not limited to displaying vehicle identification or driver identification data, the date and current time and the amount of parking time that has been purchased by the driver and/or the amount of time that is left before the paid parking time expires.

In accordance with one embodiment, a master meter controller 300 is provided along the street 10 and is in communication (e.g., wireless communication) with each of the meter displays 200. For example, the meter display 200 can include a transmitter/receiver that sends and receives signals from the controller 300. In one embodiment, each of the meter displays corresponds to a particular parking spot 110 that is identified by some type of indicia, such as a label or other type of indicia that uniquely identifies the parking spot 110. The parking spot 110 can be identified by a number or letter or a combination thereof and typically, the parking spot 110 is delineated by painted lines in the street 10.

The master meter controller 300 is configured so that it is the device at which the user (driver) pays (payment module 302) and identifies which parking spot 110 the driver is parked at. In accordance with the present invention, the controller 300 includes a number of different modules/functionality including a payment module 302 and keyboard 304 that permits the user to pay for a prescribed amount of parking time (e.g., 60 minutes, 120 minutes, etc.). For example, the controller 300 can accept any of a variety of payment options, including coins, paper money, credit cards, debit cards, and smart cards. A credit or debit card scanner can be provided at the controller 300 to permit the user to purchase parking time.

The controller 300 also preferably includes a vehicle identification device or module 310 and is therefore operatively connected to the parking meters 200. The term “operatively connected” refers to any system for communication including wireless and wired technologies (preferably, wireless communication protocol is used). The vehicle identification device 310 captures and/or identifies one or more unique characteristics of a vehicle 20. The one or more unique characteristics gathered by the vehicle identification device 310 are used to identify the owner of the vehicle, as described in greater detail below. The vehicle identification device 310 can take any number of forms so long as the device 310 permits either the vehicle and/or the driver of the vehicle to be identified. For example, the vehicle identification device 310 comprises a device capable of capturing or reading an image of the vehicle's state registration number or YIN (vehicle identification number) or insurance card or driver's license. The device 310 can thus be a component of the master controller 300 that is configured to read a piece of identification, such as the vehicle's registration, the insurance card, the driver's license, etc. Thus, the device 310 can be in the form of a reader that can read a unique identification number or sequence that is part of the piece of identification and in one embodiment, the piece of identification includes a barcode that uniquely identifies the car and/or the driver.

The driver (purchaser) that is seeking to pay for a parking space can thus walk up to the master controller 300 and make various selections, as described below, including identifying the parking spot 110 and an amount of time that is to be purchased. The purchaser also identifies either the vehicle that is parked in the spot 110 by presenting the vehicle's registration or the insurance card for reading by the device 310 or alternatively, the purchaser identifies himself or herself by presenting a driver's license for reading. The controller 300 can thus include a reader or the like that is configured to read unique identification indicia, such as a barcode, that is on the piece of identification (e.g., vehicle's registration, insurance code, driver's license, etc.). It will be appreciated that these forms of identification are required to drive the vehicle and therefore, when the driver parks the vehicle, at least one of these forms of identification is present at the time of parking.

The master controller 300 is in communication with a database that stores the identification information. For example, the controller 300 can be in wireless communication with a database that is populated by relevant state agencies, including the state department of motor vehicles. The database can be stored at a remote server. Once the user presents identification and it is read by the master controller 300 and a match is made with a record in the database, the master controller 300 will then indicate that the identification has been accepted.

In the event that the identification is not accepted due to the lack of a matching record in the database, the user will be notified on the display 310 that the presented form of identification has been rejected. The user can then present a different form of identification. Until, the user presents a form of identification that is accepted, the status of the parking spot 110 in question will not be updated.

It will also be appreciated that an identification card in a different form can be used to provide information to the master controller 300. For example, a dedicated identification issued by the relevant parking authority (e.g., a municipal parking ID) can be used and includes unique identification indicia, such as a barcode, RFID tag, etc. The reader of the controller 300 can be designed to read an RFID tag that contains the unique identification information. The identification card can thus include an RFID chip or the like. In yet another embodiment, the identification can be in the form of a device that includes a transmitter, such as an EZ-PASS device, sends a signal that can be read by the master controller 300. When the identification card or device is brought within a prescribed distance of the reader of the controller 300, the identification card is read and the user is identified. Similar to an EZPASS database, one vehicle is associated with each identification card and the user's address of record is also stored in the database.

In each of the aforementioned identification devices, an address of record of either the vehicle's owner and/or the driver is within the database and therefore, in the event that a parking violation occurs, a violation ticket can be mailed to a specific location.

Alternatively, the device 300 can be a device that is capable of capturing an image of the front and/or rear license plate of the vehicle in order to identify the vehicle and/or driver that is parked in a particular spot 110.

In one embodiment, the device capable of capturing an image is a digital still and/or video camera. In an alternate embodiment, an analog still and/or video camera may be used. The vehicle identification device 300 can further comprise a time/date logger (not shown). The time/date logger can log the time and date of each imaged captured by the vehicle identification device. In one embodiment, the time/date logger can superimpose on the image the time and date that an image is captured using any of a variety of techniques known to those skilled in the art.

It is understood that the vehicle identification device can capture any number of images, as is contemplated by those skilled in the art. It is further understood that the vehicle identification device can be operated continuously or in regular intervals. The vehicle identification device can be controlled manually by a human or automatically through various software and/or hardware implementations, as contemplated by those skilled in the art. As illustrated in FIG. 1, only one vehicle identification device is shown. It is understood, however, that any number of vehicle identification devices can be used, as is contemplated by one skilled in the art.

In yet another aspect of the present invention, the system 100 includes a vehicle sensor 400 that is configured to detect whether a vehicle is at a particular parking spot 110. The vehicle sensor 400 can be incorporated as part of the upstanding meter 200 or it can be part of or be mounted to some other structure that is close to the parking spot 110 to permit detection of whether a vehicle 10 is present in the parking spot 110.

For example, in one exemplary embodiment, the vehicle sensor 400 can be in the form of an optical sensor that is configured to detect whether a vehicle is in the spot 110. For example, the sensor 400 can be configured so that a beam is directed to the parking spot 110. To make sure that a vehicle 10 is parked in the spot 110, the sensor 400 can emit two light beams one toward the front of the parking spot 110 and the other toward the rear of the parking spot 110. This allows for detection of various sized cars and is not dependent upon the vehicle being in a specific location of parking spot 110.

A sensor can be in the form of a fiber optic sensor and the fiber optic fiber can act as not only the means for delivering the light beam but also can act as a collector that collects reflect light and permit detection of the vehicle based on the degree of reflection. For example, a conventional fiber optic sensor can be configured so that when an object is present, an increase in the observed reflectance is realized and indicates that an object is within the path of the beam.

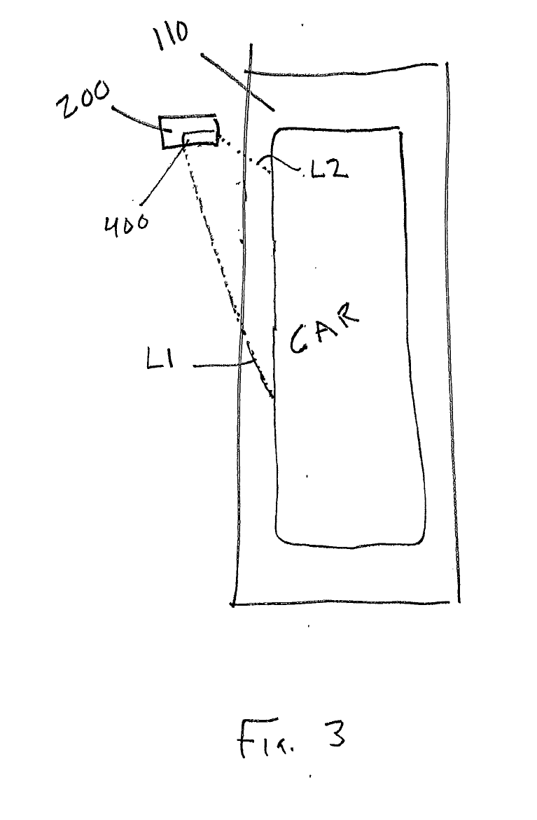

In another embodiment of the present invention, the sensor 400 is in the form of an optical laser distance sensor that is capable of detecting an object that is within a prescribed distance from the sensor 400. For example, optical laser distance sensors can detect objects that are up to 13 feet away. Similar the other sensor described herein, the sensor 400 can actually be a dual sensor in that two laser beams emanate from the meter pole that carries the sensor 400. One laser beam is directed toward a forward or front location of the parking spot, while the other laser beam is directed toward a rear or back location of the parking spot. The sensor 400 is designed to take measurements from the two laser beams and determine if an object is detected within a threshold distance (which can be up to the maximum distance of the laser beam). As shown in FIG. 3, by having two laser beams (L1 and L2) redundancy is provided and this ensures that an object is detected at two different locations within the parking spot as is the case when a vehicle is parked therein. Thus, if an object other than a vehicle (e.g., a garbage container) is located within the parking spot, it is unlikely that the size of this object is sufficient to be detected by both laser beams since this would require the object to occupy substantially the entire parking space, as is the case when a vehicle parks in the parking spot. The software running the sensor 400 can be configured so that if only one laser beam detects an object within the prescribed distance, while the other laser beam does not detect an object, the sensor will note this event but will not trigger a determination that a vehicle is present in the parking spot (since both laser beams would have to detect an object within the threshold distance for a vehicle to be detected).

If no vehicle is sensed, the signal from the sensor will cause the display at the parking meter to show an indicator (light) that indicates that no parking fee has been paid and the meter is available for payment.

The software that operates the sensor can be configured so that it filters out non-vehicle events, such as person walking by or some other object temporarily coming into contact with the sensor beam.

It will be appreciated that the sensor 400 is preferably located at or near the top end of the parking meter so as to reduce the chance that an object, other than a vehicle, will interfere with the sensor. In addition, while the use of two sensor beams ensures greater accuracy, it will be understood that the parking meter structure can include a single sensor beam.

In yet another embodiment, the presence of a vehicle 10 can be detected by using inductive loop technology. An inductive loop is simply a coil of wire embedded in the road's surface within the confines of a parking spot. To install the loop, they lay the asphalt and then come back and cut a groove in the asphalt with a saw. The wire is placed in the groove and sealed with a rubbery compound. Inductive loops work by detecting a change of inductance using a meter or the like. When a car is parked over the coil, the inductance will be much larger because of the large steel object positioned in the loop's magnetic field. The car parked over the coil is acting like the core of the inductor, and its presence changes the inductance of the coil. When a change in inductance is detected, a signal is sent to a device that can be a part of the meter 200 or it can be sent directly to the controller 300. Conversely, when no vehicle 10 is within the spot 110, the inductance of the coil is less.

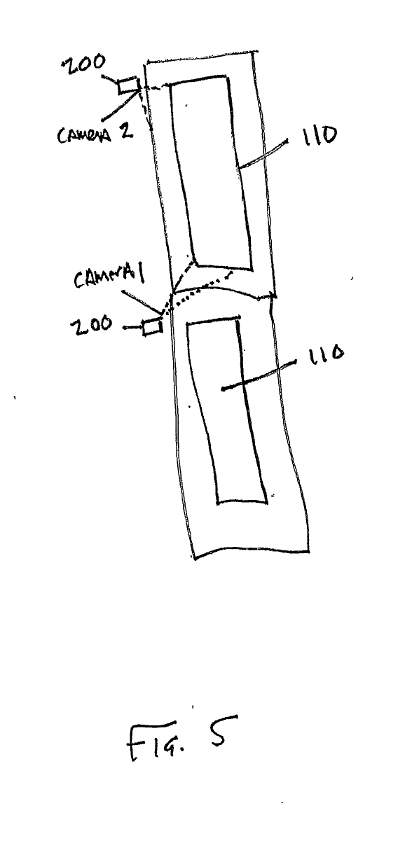

As shown in FIGS. 2 and 5, the identification of the vehicle can also be recorded by having a pair of cameras 500 that operate together for procuring an image of either the front or rear license plate. For example, as shown in FIG. 1, one parking meter that is assigned to a first parking spot can have a first camera that is aimed at a first end of the first parking spot, while another parking meter that is assigned to a second parking spot can have a second camera that is aimed at a second end of the first parking spot. The cameras can have independent sensors that detect when an object is within a prescribed distance from the camera and cause a signal to be generated resulting in an image being taken with the camera. Alternatively, the camera can be actuated using information obtained by the vehicle sensor 400 in that in the case of using an optical laser distance sensor, when the sensor 400 detects a vehicle, a signal can be sent to the camera to take an image. Since the overall system knows which pairs of cameras are directed at which parking spots, a control signal can easily be sent to a particular pair of cameras

Since the first and second cameras are monitoring and are directed to the same spot, the cameras will capture either or both of the front license plate and the rear license plate regardless of how the vehicle enters the parking spot. The images obtained by the cameras can be sent along with the other information (identification information) to the central controller/processing and storage site.

The system of the present invention also includes a violation manager that keeps track of parking violations for each of the parking spaces. The violation manager can comprise a timer as described herein. A violation can occur in two basic ways: (1) an “unpaid” scenario; and (2) an “expired” scenario. In the unpaid scenario, the vehicle parks in the parking space and the vehicle is sensed by one of the sensor mechanism described herein. At this point, a timer can start. The timer may be executed by the parking meter or the vehicle sensor. A driver of the vehicle is given a finite amount of time in which he or she has to deposit a sufficient amount of money in the main parking meter controller along the street as described hererin. If the driver of the vehicle fails to deposit the sufficient amount of money within that finite amount of time (i.e., the time on the timer exceeds the finite amount of time given to deposit the money), a violation for the vehicle is recorded. In addition, it is likely that the driver did not provide identification information (e.g., a vehicle registration, insurance card, etc.) at the main parking meter controller and therefore, identification of the vehicle can occur by means of analysis of the images of the license plate taken by the camera(s). In addition, the indicator at the parking meter can change to reflect a violation status (e.g., red light) and if the vehicle is positively identified, a violation can be processed and optionally, a violation number can be displayed on the parking meter display as mentioned herein. In addition, as mentioned herein, an alert can be sent to a particular agency (traffic enforcement) indicating that a specific meter is expired and that a vehicle is present at the spot. This permits optional in person enforcement.

In the expired scenario, the driver of the vehicle timely deposits the sufficient amount of money in the parking meter (e.g., main control unit). Once the money is deposited, the driver is allowed to park his or her vehicle for the purchased amount of time. This may be implemented by setting the timer once the driver deposits the sufficient amount of money. Once the driver parks his or her vehicle in excess of the purchased amount of time (e.g., the timer exceeds the purchased amount of time), the violation for the vehicle is recorded.

It is understood that the parking meter comprise at least part of the violation manager. It is further understood that separate timers may be used for the unpaid and the expired scenarios.

Notice of the violation and the identification information, along with optionally one or more captured images of the violating vehicle are sent to a central office via a network. Alternatively, the notice of the violation and other information can be sent to the municipality that owns the meters. The central receiving office can be located inside or outside of the municipality where the parking meters are located. In one embodiment, the central receiving office is capable of receiving notices of violations and captured images from numerous parking meters located in different municipalities.

The central receiving office receives the notice of the violation and the one or more captured images, and, in response to receiving the notice, automatically processes the information to determine the identity of the owner of the vehicle. For example, the owner of the vehicle can be retrieved, for example, by comparing the scanned (read) identification information with state vehicle records. If images of the license plate are delivered, the central receiving office processes the images to identify the owner of the vehicle. The owner of the vehicle may be retrieved, for example, by comparing license plate information (i.e., state license plate is issued and unique identifier) of the vehicle to vehicle records for the state given on the vehicle's license plate or state registration sticker. The license plate information may be determined from the one or more captured images using a character recognition unit, as is known to those skilled in the art. The character recognition unit preferably converts a digital image to corresponding alphanumeric characters. Alternatively, a human can view the one or more images to determine the alphanumeric characters. The alphanumeric characters may be used to search a database of the vehicle records to identify the owner of the vehicle. The vehicle records may be obtained, for example, through a state driving records agency, such as a state DMV (Department of Motor Vehicles) or a state DPS (Department of Public Safety).

Once the owner of the vehicle is identified, a summons may be automatically created. The summons may also be mailed to the owner or the municipality. The summons can be created in cooperation with the municipality issuing the summons. The summons may state that a fine is to be paid as a result of the violation.

In one embodiment, the central receiving office further automatically checks the vehicle records for any past unresolved or unpaid violations. For example, the owner of the vehicle may have outstanding parking tickets. If the central receiving office determines that the owner of the vehicle has past unresolved or unpaid violations, the central receiving office notifies the municipality that owns the multi-bay parking meter of the current and past violations. If the vehicle is still in the parking space, then the municipality can impound or boot the vehicle accordingly.

The automated enforcement system described herein provides many advantages over existing systems. For example, enforcement of parking spaces in a parking lot or garage may be accomplished automatically and without human enforcement. Every parking space in a parking lot or garage may be simultaneously observed and enforced. Because a violation is immediately recorded when the violation occurs, no revenue is lost by the municipality that owns the parking meter. Furthermore, by accounting for whether a vehicle is in each parking space, a parking meter can control a display of available parking spaces without the use of a separate unit or induction loops.

In another aspect of the present invention, a sliding scale of violation amounts can be generated and used as part of a scheme. For example, if a violation is generated, the driver can be given the option of making immediate payment of the violation on the street at the time of the infraction by either paying at the parking meter or at the main parking meter controller on the street where the vehicle or driver identification was presented and initial payment was available or made. For example, a 10% discount can be offered for immediate payment of the violation and this saves money by avoiding having to mail the violation and later collect the fine. If the driver pays the fine prior to it being mailed (e.g., violations can be programmed to be printed and mailed a certain number of days after the violation), a lesser discount can be offered for full payment (e.g., 5% discount). Full payment is required if the violation notice is generated and sent to the violator.

If a special identification card is used to identify the driver and/or vehicle, the card can be linked to a credit and have automatic authorization to charge the credit card in case of a violation.

In addition, there can be programmable grace periods in that the violator can be given a period of time, such as five minutes, to return and move the vehicle after a violation has occurred. Since the vehicle sensor will detect when the vehicle leaves the parking space, if the driver departs before the grace period ends, a violation notice is not generated. The indicator on the parking meter can alert the driver that a violation is impending and that action is needed immediately to avoid the violation by moving the vehicle. The indicator can have a yellow light that indicates a violation is imminent.

Since the display on the individual meters is connected via a network to one or more controllers, the display can be programmed to display any number of different messages and/or display different indicators. For example, if a snow emergency exists, the parking meter can indicate that no parking is permitted and the main controller can be programmed not to accept payment. In the case of a special event where free parking is offered, the meter can indicate such.

In yet another aspect, the present invention prevents people from paying for excessive parking limits by paying for more time than allowed by the meter. For example, some meters only allow 1 hour parking and people can try to feed the meter for successive hours which is in violation of the parking rules. Meter enforcement personnel often apply a chalk mark on the tire to indicate which cars were present at a known time and then after an hour, the personnel comes back and if vehicles are present with chalk marked tires, a ticket can be generated. Since the vehicle sensors of the present invention know whether the vehicle ever left the parking spot 110, the driver will not be able to purchase additional parking time for a spot

In addition, when a vehicle is not sensed (e.g., the car leaves the spot), the settings of the master controller and the parking meter can be reset to default settings (e.g., none time shown on the meter, etc.).

In yet another embodiment, the system of the present invention can be devised to provide an optional service to an individual. In particular, an optional service can be provided to allow the individual to ascertain where parking spots are available.

This service can be provided to individuals over a network and can be in the form of a website or a smart phone application that provides the individual with an interface that permits the individual to search a specific area for currently available parking spots. This can be provided in the form of an interactive map that shows available parking spots. For example, available parking spots can be shown in green or otherwise can be visually highlighted on a map or some other type of display. A subscription fee can be obtained from the individuals to pay for this service. The interface can include user searchable fields, such as location (street address), etc.

This service is possible since the present system, as described above, continuously monitors whether a vehicle is detected within a particular spot. Thus, a global map or listing of available spots (spots where vehicles are not detected) can easily be generated by the present system and be updated in real-time.

Another subscriber based service can be an alert system where the user can input certain desired search terms, such as a street, a period of time, etc. and once a parking spot meeting that criteria becomes available, an alert can be sent. For example, alerts can be sent when a spot is available along a particular street.

It will also be appreciated that as mentioned herein, a parking violation can be paid for at the time of the violation if the violator desires to do so. This can be done right at the location of the infraction (i.e., the meter of the individual). In addition, the violation can be paid for at another location, such as another meter or at the master meter that is located on the street. The user can simply enter a violation number into the user interface at this meter or some other device and then use a credit card, etc. to pay for the violation. Depending upon the date of the violation and the date of the payment, a reduced rate may be offered to the individual.

Since the present system is programmable, the present system can also be configured so that different parking rates exist depending upon some parameter, such as the time of day. For example, there can be off-peak parking rates and peak parking rates and also, Holiday rates can be programmed. Thus, when an individual parks at a meter during an off-peak time period, a reduced parking rate can be offered, while if the individual parks at the meter during peak hours, increased rates are in place. The system can thus be easily programmed to meet the needs and the changing rules and regulations and changing calendar, etc.

While the invention has been described in connection with certain embodiments thereof, the invention is capable of being practiced in other forms and using other materials and structures. Accordingly, the invention is defined by the recitations in the claims appended hereto and equivalents thereof.

What is claimed is:

1. A parking meter system with automated ticket generation for a parking violation comprising:
a base portion that has a user interface that allows a user to enter parking space information and enter payment instructions to pay for a prescribed time period of parking and enter vehicle or user identification information;
a controller that is in communication with the user interface;
a sensing means for determining whether a vehicle is within a designated packing spot, the means being configured to determine whether an object sensed within the parking spot is a vehicle by determining a distance to the object from the base portion and by evaluating whether the object occupies both a forward zone and rearward zone of the parking spot; and
wherein when the prescribed time period of parking expires, the controller determines whether the vehicle is still within the parking spot by information received from the sensing means and if so, a parking violation is automatically generated and sent to an address that is known from either the vehicle or user identification means;
wherein if the sensing means determines that a vehicle is not present in the parking spot,t the parking spot is classified as vacant and ready for payment by a next customer.
